(19) United States
(12) Patent Application Publication
(10) Pub. No.: US 2010/0003382 A1
(43) Pub. Date: Jan. 7, 2010

(54) APPARATUS AND METHOD FOR STORING MATERIALS

(75) Inventors: Jeongje PARK, Hwaseong-si (KR); Kyungil CHO, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/266,918

(22) Filed: Nov. 7, 2008

(30) Foreign Application Priority Data
Jul. 2, 2008 (KR) 10-2008-0063794

(51) Int. Cl. A23L 3/005

(52) U.S. Cl. 426/234; 204/196.01

(57) ABSTRACT

An apparatus and method for storing materials includes an electrode unit comprising at least one electrode which applies an electric current to materials including microorganisms; and a power generating unit which applies an alternating current power to the electrode unit, wherein the magnitude of the electric current, which flows through the materials per cross-sectional area perpendicular to the flow of the electric current is at least about 10 μA/cm².

This application claims priority to Korean Patent Application No. 10-2008-0063794, filed on Jul. 2, 2008, and all the benefits accruing therefrom under 35 U.S.C. §119, the contents of which in its entirety are herein incorporated by reference.

### BACKGROUND OF THE INVENTION

1. Field of the Invention

The present invention relates to an apparatus and a method for storing materials. More particularly, the present invention relates to an apparatus and a method for storing materials, which an electric current of a selected magnitude is applied to the materials and growth of microorganisms in the materials is inhibited or facilitated based on a frequency of an electric current applied to the materials.

2. Description of the Related Art

In general, refrigeration is a way to store food freshly and safely over a long period of time. Food is generally stored in home refrigerators with a temperature range of about 0° C. to 3° C. However, at this temperature, food can be kept only for about 3 or 4 days due to growth of microorganisms and discoloration caused by oxidation.

Thus, it is desired to develop an apparatus and method for controlling the growth of microorganisms in food refrigerated for a long period of time.

### BRIEF SUMMARY OF THE INVENTION

An exemplary embodiment of the present invention provides an apparatus for storing materials wherein a power generating unit applies an alternating current power to an electrode unit comprising one or more electrodes, and the electrode unit applies an electric current to the materials. The magnitude of the electric current, which flows through the materials per cross-sectional area perpendicular to the flow of the electric current is at least about 10 μA/cm².

In an exemplary embodiment of the present invention, the power generating unit may apply an alternating current power with a frequency from about 10 Hz to about 1 kHz to the electrode unit in order to inhibit the growth of microorganisms in the materials. The power generating unit may apply an alternating current power with a frequency from about 10 kHz to about 1 MHz to the electrode unit in order to facilitate the growth of microorganisms in the materials.

In an exemplary embodiment of the present invention, a magnetic field may be applied to the materials by a magnetic field generating unit.

An exemplary embodiment of the present invention also provides a method for storing materials in which a material is stored in a receptacle; at least one electrode of an electrode unit is disposed in electrical communication with the material; at least one of an alternating current power having a first frequency and an alternating current power having a second frequency is selectively applied to at least one electrode of the electrode unit.

### BRIEF DESCRIPTION OF THE DRAWINGS

The above and other aspects, features and advantages of the present invention will be more readily apparent by describing in further detail exemplary embodiments thereof with reference to the accompanying drawings, in which:

FIG. 1 is a schematic illustration of an apparatus for storing materials according to an exemplary embodiment of the present invention;

FIG. 2 is a perspective view of a contact area of materials stored in a receptacle of the apparatus for storing materials of FIG. 1;

FIG. 3 is a graph of a waveform of an alternating current voltage applied to the apparatus for storing materials of FIG. 1;

FIG. 4 is a graph showing a result of inhibited or facilitated growth of microorganisms using the apparatus for storing materials of FIG. 1;

FIG. 5 is a schematic illustration of an apparatus for storing materials according to another exemplary embodiment of the present invention; and

FIG. 6 is a schematic illustration of an apparatus for storing materials according to another exemplary embodiment of the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

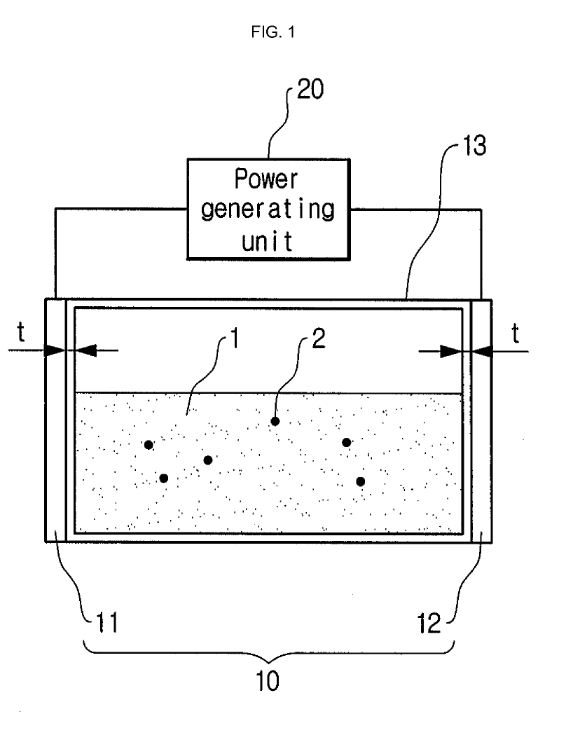

FIG. 1 is an apparatus for storing materials according to an exemplary embodiment of the present invention. The apparatus for storing materials may include an electrode unit 10, which applies an electric current to materials 1, and a power generating unit 20 which applies an alternating current power to the electrode unit 10.

The electrode unit 10 is a device for applying an electric current to the materials 1 and may include one or more electrodes 11, 12. In FIG. 1, the electrode unit 10 includes a pair of plate-shaped electrodes 11, 12 which are connected to either side of a receptacle 13, which stores the materials 1, and are opposite to each other.

The receptacle 13 is made of a material which may enable the flow of an electric current between the two electrodes 11, 12 through a contact area with the electrodes 11, 12 and through the materials 1 in the receptacle 13 when a sufficient voltage or current is applied between the two electrodes 11, 12.

A thickness t of the receptacle 13 at the contact area with the two electrodes 11, 12 may be adjusted considering the magnitude of the electric current flowing through the materials 1. For example, if the thickness t of the receptacle 13 is too large, the magnitude of the electric current flowing through the receptacle 13 decreases. The thickness t of the receptacle 13 may be controlled appropriately such that an electric current with a selected magnitude flows through the materials 1, as will be described later.

The two electrodes 11, 12 may be made of a conductive material in order to apply an electric current to the materials 1. For example, the two electrodes 11, 12 may be made of gold (Au), silver (Ag), nickel (Ni), chromium (Cr), copper (Cu), aluminum (Al) or a transparent electrode (indium tin oxide; “ITO”), for example, but is not limited thereto. The electrodes may also be made of a conductive material with low magnetic permeability in order to prevent the electrodes 11, 12 from detaching from a magnet which applies a magnetic field. Further, the electrodes 11, 12 in the exemplary embodiment of FIG. 1 are connected to side surfaces of the receptacle 13 to effectively apply an electric current to the materials 1 as the materials 1 contact inner side surfaces of the receptacle 13.

However, according to an exemplary embodiment of the present invention, for example, if the materials 1 contact upper and lower inner surfaces of the receptacle 13, the electrodes 11, 12 may also be connected to the upper and lower inner surfaces of the receptacle 13. Alternatively, each of the electrodes 11, 12 may be connected at any position which may be appropriate to apply an electric current with a selected magnitude to the materials 1.

The materials 1 include substances which may allow passage of an electric current. For example, the materials 1 may be food in solid or liquid state. According to an exemplary embodiment of the present invention, the materials 1 may include microorganisms 2 such as lactic acid bacteria and Escherichia coli (“E. coli”). As a result, the growth of the microorganisms 2 included in the materials 1 may be controlled by the magnitude and frequency of the electric current flowing through the materials 1, which will be described later.

The power generating unit 20 is connected to the two electrodes 11, 12 of the electrode unit 10. The power generating unit 20 may generate an alternating current voltage or an alternating electric current with a selected frequency and apply the alternating current voltage or the alternating electric current to the two electrodes 11, 12. The frequency and magnitude of the alternating current power applied by the power generating unit 20 to the electrode unit 10 may be controlled variously depending on the use of the apparatus for storing materials. For example, when the materials 1 include microorganisms 2, the power applied by the power generating unit 20 may be controlled such that the growth of the microorganisms 2 included in the materials 1 is inhibited or facilitated.

In order to control the growth of the microorganisms 2, the magnitude of the electric current flowing through the materials 1 should be about 10 μA/cm² or larger.

The magnitude of the electric current flowing through the materials 1 refers to the magnitude of the electric current flowing through the materials per cross-sectional area perpendicular to the flow of the electric current.

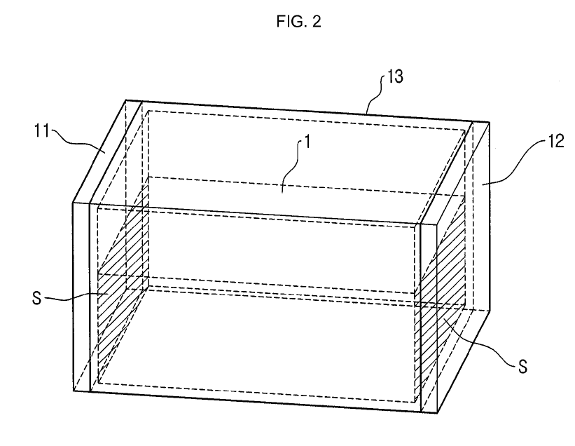

For example, referring to FIG. 2, electrodes 11, 12 are connected at the side surfaces of the receptacle 13 and materials 1 are held in the receptacle 13. Assuming that the magnitude of the electric current applied to the electrodes 11, 12 is (“I”) and that the cross-sectional area of a portion where the electric current is applied to the materials 1 through the receptacle 13 is (“S”), the magnitude of the electric current (“i”) flowing through the materials 1 is defined by the following Equation 1.

$$i = \frac{I}{S} \qquad Equation 1$$

Accordingly, by controlling the magnitude of the power applied to the electrodes 11, 12 by the power generating unit 20 depending on the cross-sectional area of the portion where the electric current is applied to the materials 1, the magnitude of the electric current flowing through the materials 1 may be controlled. For example, the magnitude of the power applied to the electrodes 11, 12 by the power generating unit 20 may be controlled such that the magnitude of the electric current flowing through the materials 1 is about 10 μA/cm² or larger.

The growth of the microorganisms 2 included in the materials 1 is affected by the frequency of the electric current flowing through the materials 1. For example, if the frequency of the alternating current power applied to the electrode unit 10 by the power generating unit 20 is from about 10 Hz to 1 kHz, an electric current with a frequency from about 10 Hz to 1 kHz may be applied to the materials 1 by the electrode unit 10. When an electric current of this frequency range is applied, for example, the growth of the microorganisms 2 may be inhibited and the cell membrane of the microorganisms 2 may be damaged by an electric field.

Alternatively, if the frequency of the alternating current power applied to the electrode unit 10 by the power generating unit 20 is from about 10 kHz to about 1 MHz, an electric current with the same frequency may be applied to the materials 1. As a result, the growth of the microorganisms 2 included in the materials 1 may be facilitated by the electric field.

According to an exemplary embodiment of the present invention, the magnitude of the applied electric current flowing through the materials 1 may be controlled such that the magnitude is above a selected critical value. Based on experiments, for example, the growth of the microorganisms 2 is inhibited when an alternating electric current with a frequency of about 100 Hz is applied to the materials 1. As a result, the magnitude of the electric current flowing through the materials 1 is about 50 μA/cm² or larger.

Also, the growth of the microorganisms 2 is facilitated when an alternating electric current with a frequency of about 100 kHz is applied to the materials 1. As a result, the magnitude of the electric current flowing through the materials 1 is about 40 μA/cm² or larger.

Accordingly, by controlling the frequency and magnitude of the electric current flowing through the materials 1 as described above, the microorganisms 2 included in the materials 1 may be controlled, that is, the growth of the microorganisms may be inhibited or facilitated.

The apparatus for storing materials according to an exemplary embodiment of the present invention may be used for various applications to inhibit or facilitate the growth of microorganisms included in materials 1. For example, the apparatus for storing materials may be installed in a refrigerator to inhibit the growth of microorganisms and keep food fresh. Alternatively, the apparatus for storing materials may be installed in refrigerators especially made for storing Kimchi (e.g., common side dish eaten at every Korean meal with rice), for example, to reduce time required for ripening of Kimchi by facilitating the growth of lactic acid bacteria. The apparatus for storing materials may also be used to facilitate production of heterologous proteins by E. coli at a low temperature by facilitating the growth of E. coli.

Meanwhile, with the increase of the magnitude of the electric current applied to the materials 1, the temperature of the materials 1 may be increased due to the electric current. Because the growth of microorganisms 2 is facilitated as ambient temperature increases, the increase of the temperature of the materials 1 may result in facilitated growth of the microorganisms 2, regardless of or beyond the effect of the electric current applied to the materials 1.

Therefore, for effective control of the growth of the microorganisms 2, the increase of the temperature of the materials 1 may be prevented while applying a sufficient magnitude of electric current to the materials 1.

Also, the alternating current power applied to the electrode unit 10 by the power generating unit 20 is controlled to have a selected duty ratio in order to prevent facilitated growth of the microorganisms due to a temperature increase.

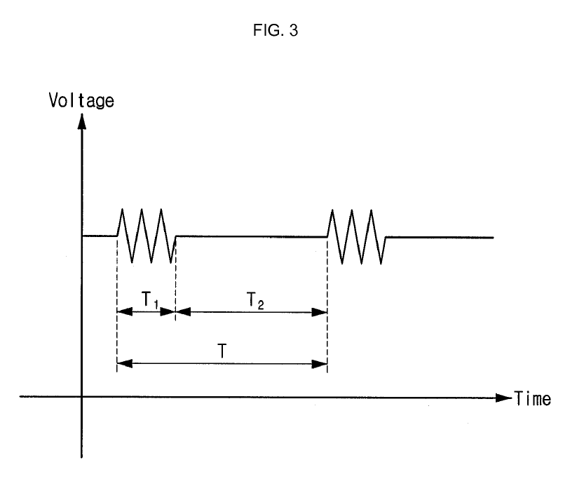

FIG. 3 is a graph of a waveform of an alternating current voltage applied to an apparatus for storing materials according to an exemplary embodiment of the present invention. Referring to FIG. 1 and FIG. 3, the waveform of the alternating current voltage applied to the electrode unit 10 by the power generating unit 20 has a selected period T. The period T includes an on-duty period T₁ during which a voltage is applied to the materials and an off-duty period T₂ during which a voltage is not applied to the materials.

As used herein, the duty ratio refers to the ratio of the on-duty period T₁ to the off-duty period T₂.

According to an exemplary embodiment of the present invention, the power generating unit 20 may apply an alternating current power having a duty ratio of 1:N to the electrode unit 10. Here, N is an arbitrary real number with a value of 1 or larger. When the duty ratio of the alternating current voltage applied to the electrode unit 10 is controlled, an amount of electric energy transferred to the materials 1 may be decreased and the magnitude of the electric current applied to the materials 1 by the electrode unit 10 is maintained above a selected value. Accordingly, it is possible to prevent the increase of the temperature of the materials 1.

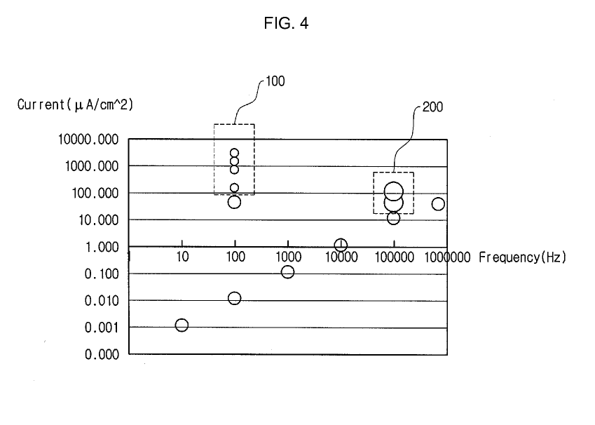

FIG. 4 is a graph showing a result of inhibited or facilitated growth of microorganisms using an apparatus for storing materials according to an exemplary embodiment of the present invention. In FIG. 4, x- and y-coordinates are the frequency of the electric current applied to the materials and the magnitude of the electric current in log scale, respectively. Circles drawn in the graph represent a number of microorganisms included in the materials (larger circle denotes more microorganisms).

In FIG. 4, the frequency and magnitude of electric current are variously changed. As a result, a decrease in the number of microorganisms is confirmed when the frequency is about 100 Hz and the magnitude of the electric current is about 50 μA/cm² or larger (region 100 marked by broken line). That is, the growth of microorganisms is inhibited in the region 100.

In contrast, an increase in the number of microorganisms is confirmed when the frequency is about 100 kHz and the magnitude of the electric current is about 40 μA/cm² or larger (region 200 marked by broken line). That is, the growth of microorganisms is facilitated in the region 200.

Accordingly, it can be seen from FIG. 4 that, by controlling the frequency and magnitude of the applied electric current applied to the materials within the above described selected ranges, the growth of microorganisms included in materials may be inhibited or facilitated.

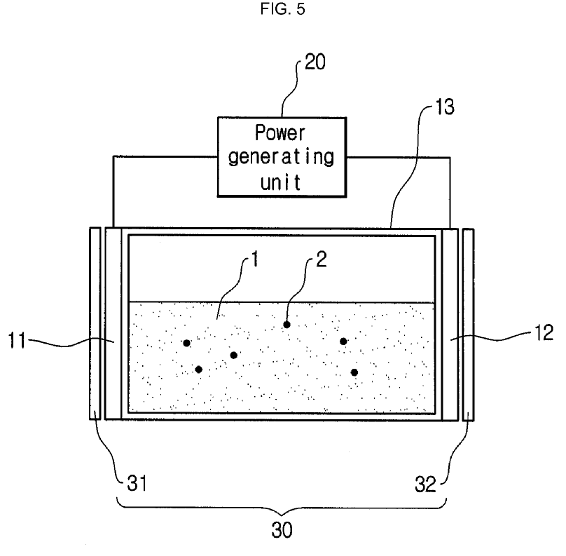

FIG. 5 is a schematic illustration of an apparatus for storing materials according to an exemplary embodiment of the present invention. Referring to FIG. 5, the apparatus for storing materials includes an electrode unit 11, 12, a power generating unit 20 and a magnetic field generating unit 30. The construction and function of the electrode unit 11, 12 and the power generating unit 20 are the same as the exemplary embodiment illustrated in FIG. 1, and, thus, detailed descriptions thereof will hereinafter be omitted.

The magnetic field generating unit 30 includes two magnets 31, 32 positioned close to the two electrodes 11, 12. The magnets 31, 32 may be in contact with the electrodes 11, 12 or may be separated from the electrodes 11, 12 with a selected spacing. Each of the magnets 31, 32 may be either a permanent magnet which applies a constant magnetic field or an electromagnet which applies an alternating magnetic field.

Each of the magnets 31, 32 of the magnetic field generating unit 30 applies a magnetic field to the materials 1. If the materials 1 include microorganisms 2, the growth of the microorganisms 2 may be facilitated by the magnetic field as ionic mobility is activated. Therefore, when a magnetic field is applied to the materials 1 along with an electric current with a frequency from about 10 kHz to about 1 MHz, the growth of the microorganisms 2 may be facilitated further than when only the electric current is applied.

In an exemplary embodiment of the present invention, instead of installing magnets 31, 32 in addition to the electrodes 11, 12, the electrodes 11, 12 themselves may be formed as magnets, such that an electric current and a magnetic field may be applied to the materials 1 by the electrodes 11, 12.

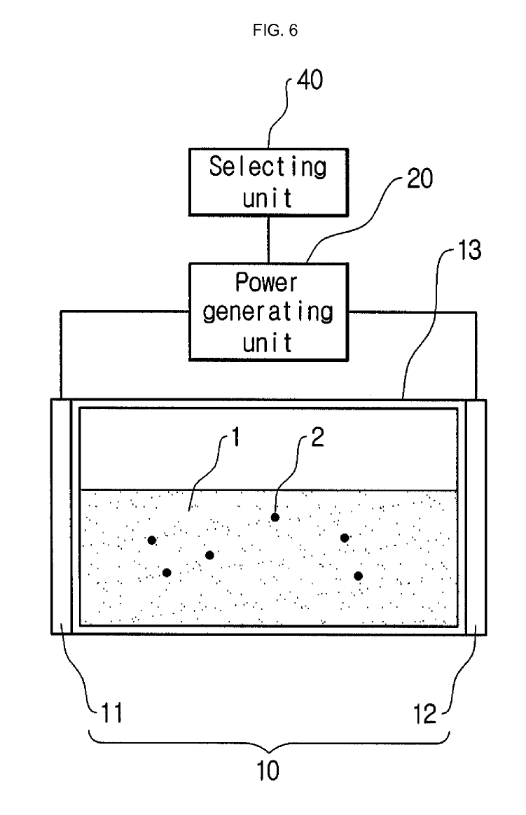

FIG. 6 is a schematic illustrations of an apparatus for storing materials according to another exemplary embodiment of the present invention. Referring to FIG. 6, the apparatus for storing materials includes an electrode unit 10, a power generating unit 20 and a selecting unit 40. The construction and function of the electrode unit 10 are the same as the exemplary embodiment illustrated in FIG. 1, and, thus, detailed descriptions thereof will hereinafter be omitted.

In FIG. 6, the power generating unit 20 may selectively apply an alternating current power having a first frequency or an alternating current power having a second frequency to the electrode unit 10. For example, the first frequency may be a frequency to inhibit the growth of the microorganisms 2 included in the materials 1 and may be from about 10 Hz to about 1 kHz. The second frequency may be a frequency to facilitate the growth of the microorganisms 2 included in the materials 1 and may be from about 10 kHz to about 1 MHz.

The selecting unit 40 is connected to the power generating unit 20 and controls the power generating unit 20 to determine the frequency of the alternating current power applied to the electrode unit 10. For example, the selecting unit 40 may determine the frequency range of the alternating current power depending on a frequency of the external input. Alternatively, the selecting unit 40 may control the power generating unit 20 according to a preset program, such that an alternating current power having a first frequency is applied for a selected duration of time and then an alternating current power having a second frequency is applied.

According to the exemplary embodiments of the present invention as described herein, an apparatus for storing materials may be employed in a refrigerator for storing food, or the like. For example, an alternating current power having a first frequency may be applied to the refrigerator for a selected duration of time in order to ripen fermented food by facilitating the growth of microorganisms. Then, an alternating current power having a second frequency may be applied to inhibit the growth of microorganisms in order to keep the fermented food fresh.

The present invention should not be construed as being limited to the exemplary embodiments set forth herein. Rather, these exemplary embodiments are provided so that this disclosure will be thorough and complete and will fully convey the concept of the present invention to those skilled in the art.

While the present invention has been particularly shown and described with reference to exemplary embodiments thereof, it will be understood by those of ordinary skill in the art that various changes in form and details may be made therein without departing from the spirit and/or scope of the present invention as defined by the following claims.

What is claimed is:

1. An apparatus for storing materials, the apparatus comprising:
an electrode unit comprising at least one electrode which applies an electric current to materials including microorganisms; and
a power generating unit which applies an alternating current power to the electrode unit,
wherein the magnitude of the electric current, which flows through the materials per cross-sectional area perpendicular to the flow of the electric current, is at least about 10 μA/cm².

2. The apparatus for storing materials as set forth in claim 1, wherein the frequency of the alternating current power applied by the power generating unit is from about 10 Hz to about 1 kHz.

3. The apparatus for storing materials as set forth in claim 2, wherein the magnitude of the electric current, which flows through the materials per cross-sectional area perpendicular to the flow of the electric current, is at least about 50 μA/cm².

4. The apparatus for storing materials as set forth in claim 1, wherein the frequency of the alternating current power applied by the power generating unit is from about 10 kHz to about 1 MHz.

5. The apparatus for storing materials as set forth in claim 4, wherein the magnitude of the electric current, which flows through the materials per cross-sectional area perpendicular to the flow of the electric current, is at least about 40 μA/cm².

6. The apparatus for storing materials as set forth in claim 4, further comprising a magnetic field generating unit which is positioned close to the at least one electrode and applies a magnetic field to the materials.

7. The apparatus for storing materials as set forth in claim 4, wherein the at least one electrode applies a magnetic field to the materials.

8. The apparatus for storing materials as set forth in claim 1, wherein the alternating current power applied by the power generating unit has a duty ratio of 1:N, wherein N is a real number which is 1 or larger.

9. The apparatus for storing materials as set forth in claim 1, wherein the power generating unit selectively applies at least one of an alternating current power having a first frequency and an alternating current power having a second frequency to the electrode unit, and
the apparatus for storing materials further comprises a selecting unit which determines the frequency of the alternating current power applied to the electrode unit by the power generating unit.

10. A method for storing materials, the method comprising:
storing a material in a receptacle;
disposing at least one electrode of an electrode unit in electrical communication with the material; and
selectively applying at least one of an alternating current power having a first frequency and an alternating current power having a second frequency to the at least one electrode of the electrode unit.
